(19) United States
(12) Patent Application Publication
(10) Pub. No.: US 2025/0383017 A1
(43) Pub. Date: Dec. 18, 2025

(54) PORTABLE TRANSMISSION CONTROL DEVICE

(71) Applicant: Keith Woolford, Torrington, CT (US)

(72) Inventor: Keith Woolford, Torrington, CT (US)

(21) Appl. No.: 19/239,466

(22) Filed: Jun. 16, 2025

Related U.S. Application Data
(60) Provisional application No. 63/660,183, filed on Jun. 14, 2024.

(51) Int. Cl. F16H 59/04; F16H 59/00; F16H 59/02; F16H 61/14; F16H 63/42

(52) U.S. Cl. CPC F16H 59/044; F16H 59/0278; F16H 61/143; F16H 63/42; F16H 2059/006

(57) ABSTRACT

A portable transmission control device for operating a vehicle transmission and bypassing any transmission control computer or vehicle computer. The device comprises a housing containing an analog electronic control circuit. A power cable provides 12 volt DC power to the control circuit and an output cable connects the electronic control circuit to solenoids of the transmission. The control circuit includes a bank of lever actuated microswitches for actuating the respective solenoids. A drum roller is aligned lengthwise with the microswitches and has a plurality of rotational positions that correspond to respective transmission gear settings (e.g., neutral, multiple forward gears, and reverse). Protrusions on the outer surface of the drum actuate respective microswitches depending on the rotational position of the drum. The operator selects rotational position, and thus transmission gear selection, with a rotary dial on the outside of the housing and connected to the drum roller.

### FIELD OF THE DISCLOSURE

The present invention relates to devices for controlling vehicle transmissions, and in particular, to a portable transmission control device for operating a vehicle transmission in a breakdown and recovery situation.

### BACKGROUND

Transmissions, particularly those heavy-duty transmissions used in commercial vehicles, are fully electronically controlled transmission involving a computer, transmission control module (TCM), an electronic key pad, a vehicle interface module, engine speed sensors, Turbin speed sensors, output speed sensors, dedicated power supplies, a very intricate wiring harness with many specialized plugs that need to be weather and corrosion proof. When any one of these items fails or becomes damaged, the transmission no longer will go into gear due to the vehicle and/or transmission control computer not seeing all the data that it was programed to see. For example, years of acid washing to remove concrete build up on concrete trucks can work its way into the wiring harnesses and corrode a wire leading to failure. There are switches and sensors that monitor what is going on in the main transmission case for the computer and if one of these fails, the processing shuts down even though the transmission is mechanically sound. Such heavy-duty transmissions are typically in large vehicles and therefore present a special recovery event when the transmission control system fails to function as built. The recovery, and lost business opportunity can be very costly.

It is with respect to these and other considerations that the disclosure made herein is presented.

### BRIEF DESCRIPTION OF THE DRAWING FIGURES

FIG. 1A is a perspective view diagram of the main body of a tool according to an embodiment.

FIG. 1B is a top view diagram of the main body of the tool of FIG. 1A according to an embodiment.

FIG. 2 is a conceptual system diagram illustrating the tool in relation to the transmission and vehicle power supply according to an embodiment.

FIG. 3 is a detailed schematic showing the control components and electronics of the tool according to an embodiment.

### DETAILED DESCRIPTION OF CERTAIN EMBODIMENTS OF THE DISCLOSURE

By way of overview and introduction, disclosed herein is a system 1, comprising a portable transmission control device 100 for operating a vehicle transmission in a breakdown and recovery situation in which the vehicle's existing systems for controlling the transmission or transmission control systems have failed.

The portable transmission control device (“device” or “tool”) 100 is a tool for emergency use when a vehicle is down. It attaches directly to the vehicle transmission, such as heavy-duty Allison transmission commonly found on commercial vehicles, and is powered by a cigarette light/power port for 12 volts. The tool ties in nowhere else to the vehicle. The tool is configured to perform manual shifting based on the operator's gear selection, and is not an automatic shifting tool. The tool is intended to be used in emergency breakdown and recovery situations and thus is configured to operate without reliance on the existing vehicle or transmission control systems and to allow the operator to drive the vehicle back safely from a breakdown, so as to save on wrecker fees and down time. The tool is not intended for daily use. The tool is configured to circumvent other vehicle functions like a Jake brake, anti-lock braking system (ABS), and the like.

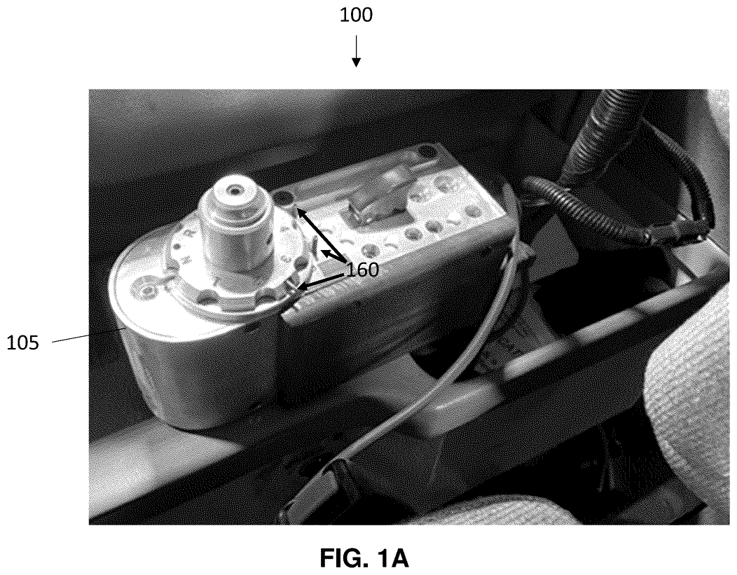

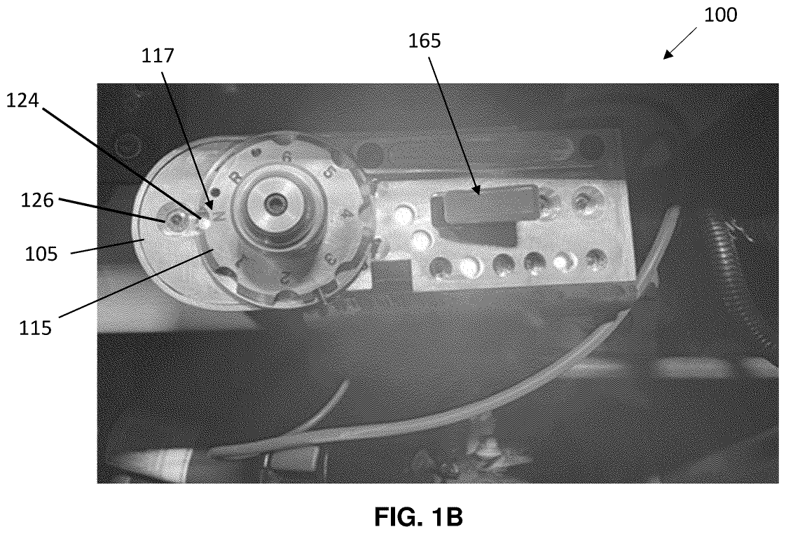

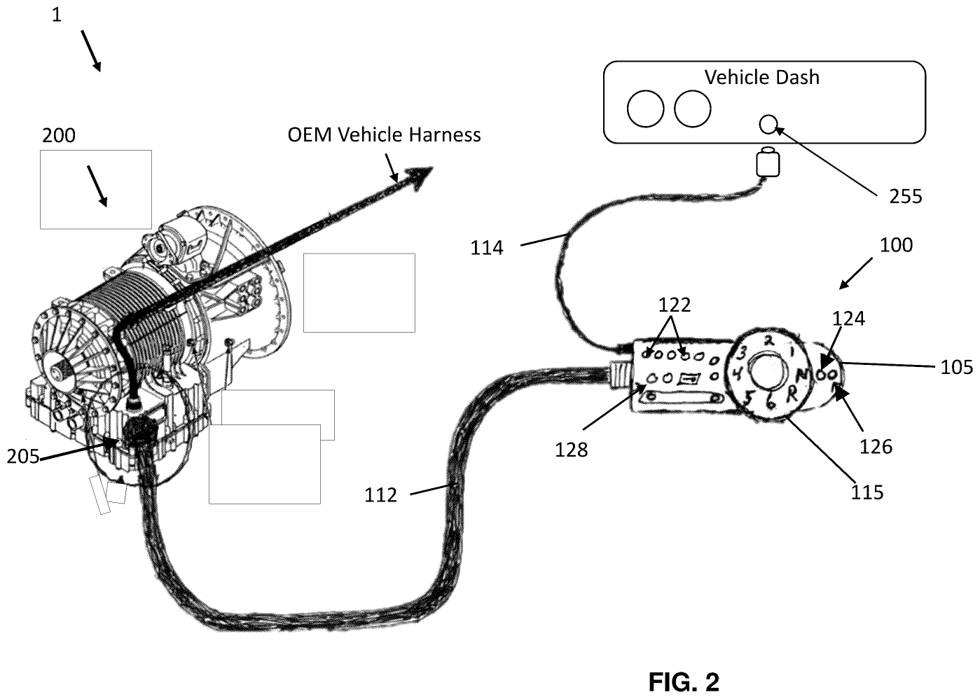

FIGS. 1A and 1B are a perspective view photograph and top view diagram, respectively, of the main body 110 of the tool 100. FIG. 2 is a conceptual diagram of the system 1 illustrating the tool 100 in relation to the transmission 200 and vehicle power supply. The tool 100 is configured to plug into a 12 volt power port/cigarette lighter 255 of the vehicle and the cord 112 from the tool can be run out though the vehicle's window to the transmission 200, where it is connected to the transmission input plug 205. The tool is configured to operate totally independent of the vehicle.

The tool 100 is useable with vehicles with transmissions, more particularly, heavy-duty transmissions commonly used in commercial vehicles. Example transmissions that the tool can be used with are the Allison 3000 & 4000 series transmissions. Some of the applications and markets they are used include: Agriculture, Coach & bus, Construction, Defense, Distribution, Energy, Fire & Emergency, Mining, Municipal, Port Services, Redi-Mix Trucks, Refuse, RV-Motor Home, School Bus, Specialty, Tractor, Transit-City Bus, and the like.

The example Allison transmissions are fully electronically controlled transmission involving a computer, transmission control module (TCM), an electronic key pad, a vehicle interface module, engine speed sensors, Turbin speed sensors, output speed sensors, dedicated power supplies, a very intricate wiring harness with many specialized plugs that need to be weather and corrosion proof. When any one of these items fails or becomes damaged, the transmission no longer will go into gear due to the vehicle and/or transmission control computer not seeing all the data that it was programed to see. For example, years of acid washing to remove concrete build up on concrete trucks can work its way into the wiring harnesses and corrode a wire leading to failure. There are switches and sensors that monitor what is going on in the main transmission case for the computer and if one of these fails, the processing shuts down even though the transmission is mechanically sound. Such heavy-duty transmissions are typically in large vehicles and therefore present a special recovery event when the transmission control system fails to function as built. The recovery, and lost business opportunity can be very costly.

The tool 100 is configured to circumvent the existing computer and all the modules and key pads and wiring that are used to operate the transmission during normal operation. In the example context of a concrete mixing truck, the tool can even enable the vehicle to be driven to the job site, off load, and return back to the garage safely and without incurring any cost from a recovery. Similar benefits are made available by the tool in other industries reliant on the operation of these transmissions (e.g., military, city transit, etc.).

When a transmission related failure occurs, the tool can be placed in use with the following steps. The operator unplugs the OEM vehicle wiring harness from the large multi pin connector on the side of the transmission case and the tool is plugged directly into it thereby bypassing the computer, key pad, vehicle interface module, the speed sensors, plugs & connectors and all the wiring. As a result, the transmission is completely under the control of the tool. The vehicle effectively does not know the transmission exists anymore, but it will function and drive safely with the use of the tool controlling the transmission, per the operator input.

The tool 100 is configured to directly plug into the factory connector 205 on the transmission. The tool can be connected to its own power supply, so it is fully independent of any vehicle source of transmission failure.

In a basic configuration, the tool 100 can be configured to provide basic functionality sufficient to drive the truck (e.g., engage the transmission and select gears) to accomplish the task. In some configurations, the tool is configured to provide the basic transmission control functions, and is configured to perform diagnostic functions that can provide an indication as to whether the fault is on the truck side, or internal to the main transmission. For example, transmissions can similarly fail due to internal sensors and switches that fail. The tool is capable of operating the transmission despite such failures. The tool can also be configured to be capable of being plugged into the first gen, gen 3, gen 4, RDS, gen 5 (which is the current model) of the aforementioned Allison transmission.

The tool 100 comprises a long electrical cable 112 comprising wires that plugs into the transmission 200 on the free end. The other end of the cord is connected to the electronics housed within the body 105 of the tool. The lengthy cable enables it to be run from where connected to the transmission and into the cab of the vehicle (e.g., through an open window) where the cable is plugged into the body of the tool. As a result, the tool unit, which is portable, hand held and operated, can be placed next to the operator were ever that may be. The tool also comprises a smaller power cord 114 that is connected to the internal electronics of the tool and configured to plug into a power port 255 (e.g., vehicle 12v cigarette lighter, dedicated battery, or other suitable power supply) to power up the electronics of the tool. Furthermore, the tool can comprise a series of led lights (e.g., lights 122, 124, 126, 128) on the face of the body that form part of the diagnostics.

For context, in order to understand how the tool 100 is made and operates, it is helpful to understand the factory function of the example Allison transmission it can be used with. In its O.E.M. form the transmission is highly sophisticated with fully computerized operation that relies on many inputs and outputs, and monitors each one many times a second. The control system only knows what it was programed to understand. So, when the slightest glitch occurs and its data stream is interrupted, it goes into protection mode and all driving comes to a halt.

In one embodiment, the tool 100 comprises control electronics housed within the body and configured to avoid reliance on computer processor units. This transmission is a massive unit that is based on hard components such as planetary gear sets and clutches to apply the gear ranges. The clutch packs are applied by hydraulic pressure controlled and diverted to the various clutch packs by electric solenoids that get their signal to open or close from the computer, which is monitoring throttle position, vehicle speed, engine RPM, shift selector position ETC. While the OEM computer is looking at so many things to make a decision on what to do, the tool is configured to bypass the transmission control computer by plugging directly into the transmission, and can operate the transmission without reliance on such inputs so as to allow the vehicle to be operated and returned to home location safely and without need for emergency recovery using a wrecker/tow truck.

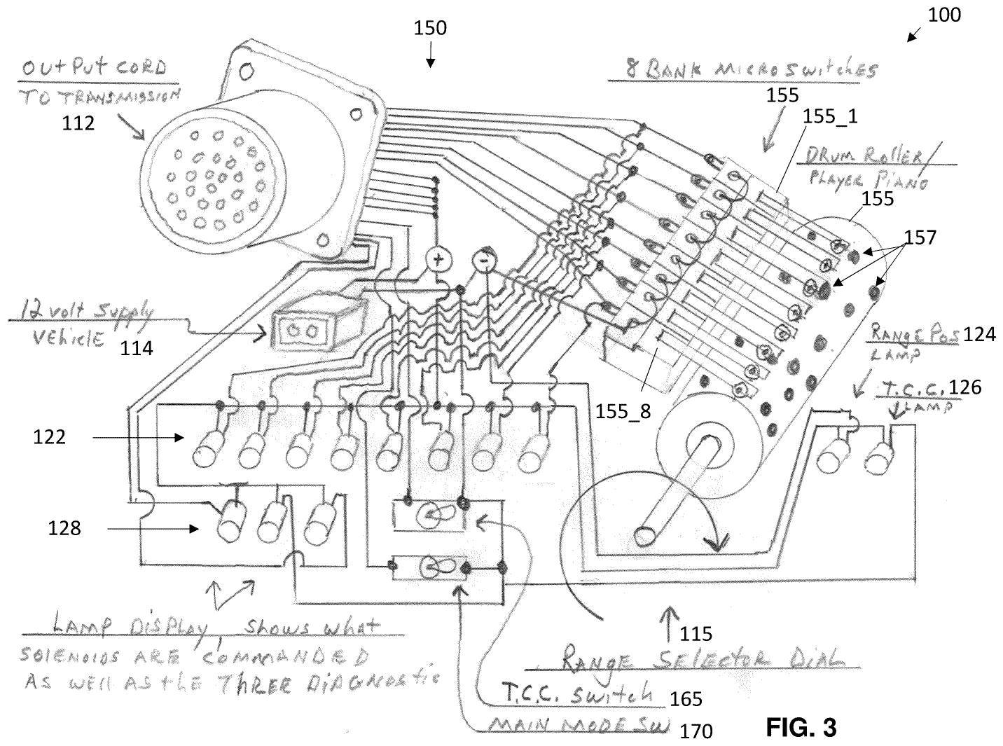

The tool is configured to apply the necessary clutches for each gear range and at the right time. Following is a more detailed description of how the tool is configured to control the example transmission that has, for example and without limitation, six solenoids wherein actuating different combinations of them apply different clutches to engage respective gears. A more detailed schematic showing the control components and electronics of the tool is shown in FIG. 3.

The tool 100 comprises a bank of lever actuated micro switches 155 all ganged together side by side. As shown in FIG. 3, a bank 155 of 8 micro-switches (155-1 . . . 155-8) can be provided. Individual micro switches among the micro switches can correspond to a respective one of the solenoids. The tool also comprises a drum roller 155 that is aligned lengthwise with the bank of microswitches. On the outer surface of the drum roller are protrusions 157, or buttons, arranged to actuate respective levers of the microswitches depending on the rotational position of the drum, like a player piano comprises a drum roller with buttons that actuate the notes/keys of a piano.

The internal electronics 155 of the tool is supplied with power, e.g., 12 volt DC via the power port plug in on the vehicle dash. The 12 volts is provided to all six solenoids (not shown) so they are “hot” all the time, and the ground side of the solenoids are connected through the micro switches 155 and thus controlled by the tool using the microswitches.

The foregoing are all contained within a case 105 (also referred to as body or housing). Exposed on the outside of the case is a rotary dial 115, that is connected to the rotary drum such that rotating the dial serves to rotate the rotary drum about its central axis. In an example, and as shown in FIG. 2 and FIG. 1B, the dial is marked and has 8 spring loaded detent positions that respectively correspond to the following transmission gear settings: NEUTRAL, 1st, 2nd, 3rd, 4th, 5th, 6th, & REVERSE.

Returning to FIG. 3, each position corresponds to a particular combination of anywhere between 0 and 8 buttons 157 protruding from the outside surface of the drum roller. At a given position of the drum roll, there can be up to 8 total buttons 157 that arranged in-line lengthwise along the drum roller. Each button is respectively aligned with a corresponding one of the microswitches (e.g., if there are 8 buttons, buttons 157_1-157_8 are aligned with micro switches 155_1-155_8 respectively).

A mechanical safety lock 160 is also provided on the rotary dial to prevent accidentally switching the rotary dial, and thus the transmission, into reverse while driving. Additionally, the tool comprises a selector position light 124 on the face, next to the selected range indicator 117, for night driving and to be sure what gear setting the tool and thus transmission is in. If it is in a forward range or reverse when the operator starts the engine, it will drive off. In the example configuration the tool does not have neutral safety switch (like the O.E.M. electronics). The tool is configured to take full control of the clutch processing without needing to see all the other sensor information. The tool further comprises a switch 165, which is protected by a safety cover, configured to trigger the torque convertor lock-up clutch if driving on highways or long distance. That is optional and not needed to drive, but can be a helpful feature for an extended trip. The tool also comprises a red light 126 that signals the T.C.C. is on.

An example operation of the tool 100 with a vehicle is described next. First the operator will start in neutral by setting the selector rotary dial 115 to that position. When ready to go the appropriate forward (or reverse) range is selected by twisting the rotary dial. Turning the rotary dial into a given position causes the tool to output a control signal to the transmission and apply the appropriate clutches for the range selected. The transmission, under control of the tool, is effectively a manual transmission at this point. The operator can upshift to the next range when desired and downshift to the lower gears when stopping and starting by twisting the rotary dial accordingly. This will serve to drive the transmissions anywhere now. As noted, the tool can be configured with diagnostic capabilities built in as well. For example, there is a C3 pressure switch in the first through 3rd generation transmission units that monitors pressures for the computer. If they fail (which they do) the transmission under control of the OEM control systems will not function, even though it is fine and it is only a monitoring switch failure. The tool is configured to drive the transmission (provides the control signals to the solenoids) without reliance on monitoring such sensor outputs (e.g., the C3 pressure switch). Nevertheless, the tool is configured to connect the C3 pressure switch to an indicator lamp (e.g., one of lamps 128) on face of the body such that, when it is supposed to function it will light the indicator lamp. Thus, if the indicator lamp is not illuminated, that indicates that the failure is internal to the transmission, rather than an external issue on the vehicle side. Similarly, in the later Generation 4 & 5's and RDS models a Main Mode 170 switch controls pressure in certain gear ranges and, the tool can be configured to connect that switch circuit to an indicator lamp (e.g., one of lamps 128) to indicate whether that is functioning. A further benefit of the tool is that it can drive home a transmission that has an internal wiring harness failure as well. For instance, an O.E.M. system would shut down immediately even if all is functioning properly except for a single solenoid that failed electrically. Using the tool, however, in the event a single solenoid failure internally, which would disable a gear set, the remaining solenoids and gears are usable. So if, say, 3rd gear is off line, using the tool, the operator can begin in 1st, shift up to 2nd, then to 3rd, but if 3rd is not there, simply shift up to 4th gear and keep going. The tool also has a bank of eight LED lamps 122 on the face of the tool that are respectively connected to the circuits that control respective solenoids so as to illuminate and display what solenoids are commanded for each range.

It should be understood that various combination, alternatives and modifications of the present invention could be devised by those skilled in the art. The present invention is intended to embrace all such alternatives, modifications and variances that fall within the scope of the appended claims.

It is to be understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A portable emergency transmission control device for operating a vehicle transmission and bypassing any preexisting transmission control computer or vehicle computer, comprising:
a housing;
an analog electronic control circuit provided within the housing;
a power cable configured to connect to a 12 volt DC power supply port of the vehicle and provide 12 volt DC power to the electronic control circuit;
an output cable configured to connect directly to the transmission and operatively connect the electronic control circuit to a plurality of solenoids of the transmission and thereby enabling the electronic control circuitry to operate the plurality of solenoids and thus the transmission;
the electronic control circuit comprising:
a bank of lever actuated microswitches arranged side by side, wherein each microswitch among the microswitches correspond to a respective one solenoid among the plurality of solenoids;
a drum roller aligned lengthwise with the bank of microswitches, the drum roller having a plurality of rotational positions, wherein each rotational position of the drum corresponds to a respective one of a plurality of transmission gear settings including a neutral gear setting, a forward gear setting, and a reverse gear setting,
wherein the outer surface of the drum roller has protrusions arranged to actuate respective levers of the microswitches depending on which of the plurality of rotational positions that the drum is at; and
a rotary dial exposed on an outside of the housing, and wherein the dial is connected to the drum roller such that rotating the dial serves to rotate the drum roller between the rotational positions,
wherein, when the rotary dial is at a given rotational position that corresponds to one of the forward gear setting and the reverse gear setting, one or more of the protrusions actuate one or more of the microswitches and thereby actuate one or more of the solenoids so as to place the transmission into the corresponding gear setting.

2. The system of claim 1, wherein the electronic control circuit is configured to provide constant 12 volt DC power to respective positive terminals of the solenoids, and wherein respective ground sides of the solenoids are selectively connected to ground through respective microswitches and thereby actuated by the microswitches.

3. The system of claim 2, wherein each rotational position of the drum roller has a particular combination of between 0 and eight protrusions protruding from the outside surface of the drum roller that are arranged to actuate between 0 and 8 microswitches respectively.

4. The system of claim 3, wherein each protrusion is respectively aligned with a corresponding one of the microswitches.

5. The system of claim 1, wherein the cable has output cable has a length sufficient to extend from within a cab of the vehicle out a window of the cab and connect to the transmission, and wherein the housing has a size that it suitable for being hand held, portable and placed near an operator of the vehicle when in use.

6. The system of claim 1, further comprising a plurality of indicator lights located on a face of the housing and connected to the microswitches so as to indicate which solenoids are actuated at any given time.

7. The system of claim 3, further comprising: eight indicator lights respectively connected to the eight microswitches and configured to indicate which solenoids are actuated at any given time.

8. The system of claim 3, wherein the control circuit is configured to circumvent the existing vehicle computer and wiring used to operate the transmission during normal operation.

9. The system of claim 1, further comprising: a mechanical safety lock provided on the rotary dial and configured to prevent accidental switching the rotary dial, and thus the transmission, from a forward driving mode into reverse.

10. The system of claim 1, further comprising: a selector position light provided on the face of the housing for indicating a selected rotational position of the drum and thus a corresponding transmission gear selection.

11. The system of claim 1, further comprising: a switch operatively connected to a solenoid of the transmission for triggering a torque convertor lock-up clutch of the transmission.

12. The system of claim 11, further comprising: a light provided on the housing and operatively connected to the switch for triggering the torque converter lock-up clutch.

13. The system of claim 1, further comprising: a light electrically connected via the cable to a C3 pressure switch of the transmission and configured to indicate a state of the C3 pressure switch.

14. The system of claim 1, further comprising: a main mode switch electrically connected via the cable to a main mode switch input of the transmission; and a light operatively connected to the main mode switch and configured to indicate a state of the main mode switch.
